(19) United States
(12) Patent Application Publication
(10) Pub. No.: US 2008/0026123 A1
(43) Pub. Date: Jan. 31, 2008

(54) Apparatus and Process for Almond Pasteurization

(75) Inventors: David Long, Merced, CA (US); Jack Wilkey, Turlock, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hilltop Ranch, Inc., Ballico, CA (US)

(21) Appl. No.: 10/558,044

(22) PCT Filed: May 20, 2004
(86) PCT No.: PCT/US04/16178

§ 371 Date: Jan. 26, 2007

Related U.S. Application Data
(60) Provisional application No. 60/473,276, filed on May 22, 2003.

(51) Int. Cl. A23L 3/00; A23L 3/005; F26B 3/00

(52) U.S. Cl. 426/461; 34/168; 34/85; 99/470

(57) ABSTRACT

A process and apparatus for shelled almond pasteurization includes counter flowing raw shelled almonds in saturated steam for a four second interval to elevate the exterior surface of the shelled almond to a temperature exceeding 160 degrees Fahrenheit. Thereafter, the pasteurized almonds are counter flowed for a two second interval in dry air before discharge to further processing or to containers for shipment. Almond taste, texture, and appearance are unchanged during the pasteurization process. The apparatus includes a steam ladder (1) defining downward paths which alternately vary the major surfaces of the shelled almonds to exposure to upwardly counter flowing steam, and an underlying drying ladder (2) for drying the raw shelled almonds upon exit from the steam ladder.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK.

Not Applicable

This invention relates to the pasteurizing of almonds. More particularly, a process and apparatus is disclosed for the pasteurization of shelled almonds to suppress external contamination of the shelled almonds by pathogens such as E. coli or Salmonella.

### BACKGROUND OF THE INVENTION

Raw shelled almonds are a familiar food. In appearance and shape, raw shelled almonds are generally elliptical when placed on a flat surface. The raw shelled almonds have two major surfaces on both sides, and taper in reduced thickness from the center of the almond to the elliptical side edges. The raw shelled almonds are elongate about the major axis of their elliptical shape and have a width about the minor axis of their elliptical shape. Common processing techniques of almonds include provisions for sliding the almonds on their major surfaces. For example, when almonds are moved during processing from an elevated disposition to a disposition having a lower elevation, the sliding of the almonds on their major surfaces by the use of so-called almond ladders is known.

Almond ladders are devices to interrupt the vertical descent of almonds, typically to prevent damage to the shelled almonds during their descent. Such devices include ladders having a downward helical path and almond ladders having a zigzag path. In this application, we are concerned with almond ladders having a zigzag path.

In such a zigzag path almond ladder device, alternating surfaces departing from the vertical are used. A typical almond ladder construction includes alternating inclined surfaces on either side of the vertical. For example, a first ladder surface can be inclined at 35 degrees with respect to the vertical to allow the major surface of a constant flow of almonds to pass over the first ladder surface. The second ladder surface can be inclined at 35 degrees in the opposite direction with respect to the vertical. This allows the opposite major surface of a constant flow of almonds to pass over the second ladder surface. Alternating similarly angularly inclined ladder surfaces are provided to the ladder. The alternating angularly inclined surfaces enable gradual and metered almond descent without damage to the raw shelled almonds.

Almond ladders are typically not enclosed. In the normal case, when almond ladders are used in an outdoor environment, enclosure occurs for the purpose of preventing moisture from having access to the flowing stream of almonds in the almond ladder.

Raw almonds are commonly used as an ingredient in many foods. Unfortunately, the very nature of almond harvesting can lead to undesired contamination, especially on the surface of the shelled almonds.

When ripe and dried on an almond tree, almonds within their shells or pods have a natural tendency to drop from the tree. Because this tendency to drop from the tree is not uniform, almonds are typically harvested by shaking a tree at least at the almond-bearing limbs and allowing the almonds contained in their shells or pods to fall to the orchard floor. Thereafter, the fallen almonds within their shells or pods are collected for harvest from the orchard ground. The almonds within their shells or pods are then routed to a so-called “sheller” where the shells or pods are removed.

Because of the nature of the harvest, it can be anticipated that, at least in some cases, the shell or pod may become contaminated with pathogens such as E. coli or Salmonella. During and after the shelling process, it is possible for the shelled almonds to be contaminated on their exterior surface with pathogens. It is known in at least one case that contaminated shelled almonds have caused illness in consumers.

Almond processing is a low margin, high-dollar, volume business. Loss of any significant portion of almonds being processed causes economic loss to the processor. Accordingly, prevention of contamination of the shelled almonds must be accomplished with expedition.

Having set forth the above parameters, we propose a novel solution. The reader will recognize that the proposed solution as well as the method of accomplishing it can constitute invention.

We propose pasteurization of the exterior surface of almonds. In this proposed pasteurization, we do not alter the taste, appearance, or other properties of the raw untreated almonds.

It is known to caramelize almonds. In caramelizing almonds, the almonds are first whetted and thereafter baked at a relatively high temperature for an extended period of time. While such carmelization naturally will sterilize the exterior of the almonds against pathogens, it is to be distinguished from the process and apparatus here illustrated. In carmelization, the taste, appearance, and properties of the almonds are changed. For example, carmelization is frequently used where it is desired to thinly slice almonds as an ingredient for food such as candy bars. With out carmelization, raw untreated almonds cannot be thinly sliced.

### BRIEF SUMMARY OF THE INVENTION

A process and apparatus for shelled almond pasteurization includes flowing raw shelled almonds in saturated steam for a four-second interval to elevate the exterior surface of the shelled almond to a temperature exceeding 160 degrees Fahrenheit. Thereafter, the pasteurized almonds are dried by flowing in dry air for a two-second interval before discharge to further processing or to containers for shipment. Almond taste, texture, and appearance are unchanged during the pasteurization process. The apparatus includes a steam ladder defining downward paths which alternately vary the major surfaces of the shelled almonds to exposure to flowing steam. This steam ladder includes an airlock for metering a flow of almonds to the top of the ladder, a moisture discharge manifold at the bottom of the ladder, and an enclosed ladder path between the top and bottom of the steam ladder. The upper portion of the steam ladder is heated so that when almonds and steam are introduced, pasteurizing steam flow occurs with the almonds. Ladder length is selected to provide the requisite four-second dwell time in the saturated steam to produce the desired pasteurization. The pasteurized almonds then pass through an airlock at the bottom of this steam ladder to a drying ladder where the almonds flow relative to ambient dry air to remove moisture. The bottom drying ladder is typically open with drying air passing across the ladder to effect drying of the almonds. Once dry, the pasteurized and dried almonds are released for shipment or further processing.

### BRIEF DESCRIPTION OF THE DRAWINGS

FIG. 1 is a over all side elevation schematic of the almond pasteurization apparatus;

FIG. 2 is a perspective view of a prior art airlock;

FIG. 3 is a side elevation section illustrating the overlying oil jacket enclosed steam ladder and the underlying trying ladder on an expanded basis;

FIG. 4 is a top plan view taken and the steam ladder illustrated the side opening insulated doors in the open position for cleaning of this steam ladder;

FIG. 5A is a view of the drying ladder in the closed, operating position with drying air being drawn through the drying ladder;

FIG. 5B is a detail of the air inlet gates to the drying ladder illustrated in FIG. 5A; and,

FIG. 5C illustrates the drying ladder in the open position for cleaning.

### DETAILED DESCRIPTION OF THE INVENTION

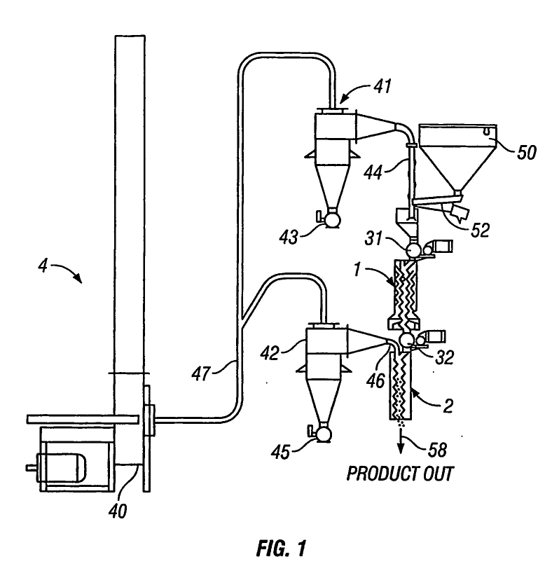

Referring to FIG. 1, the overall ventilation attached to the almond sterilization processor of this invention is illustrated. First, the major apparatus herein includes overlying steam ladder 1 where almond sterilization occurs. Because the sterilization occurs in the presence of steam, it is necessary to have an underlying drying ladder 2. Product is introduced to almond feed bin 50 passed to vibrator table 52 and introduced to the top of steam ladder 1 through steam ladder airlock 31. Almonds fall through and are pasteurized by steam ladder 1. Thereafter the almonds are metered by drying ladder airlock 32 in to drying ladder 2. When the almonds are dried at drying ladder 2, they become pasteurized almond product 58 and fall from the almond sterilization apparatus for further processing.

Over all ventilation of the almond pasteurizing apparatus is required. Ventilation apparatus 4 includes vacuum blower 40 having inlet line 47. The inlet line 47 communicates to steam ladder cyclone separator 41 and drying ladder cyclone separator 42. These respective separators have their airlocks 43, 45 for the evacuation of accumulated debris. Steam ladder cyclone separator 41 includes cyclone separator inlet 44 overlying steam ladder 1. Likewise, drying ladder cyclone separator 42 includes drying ladder cyclone separator inlet 46 overlying drying ladder 2. In this manner, systematic ventilation of the apparatus here disclosed occurs.

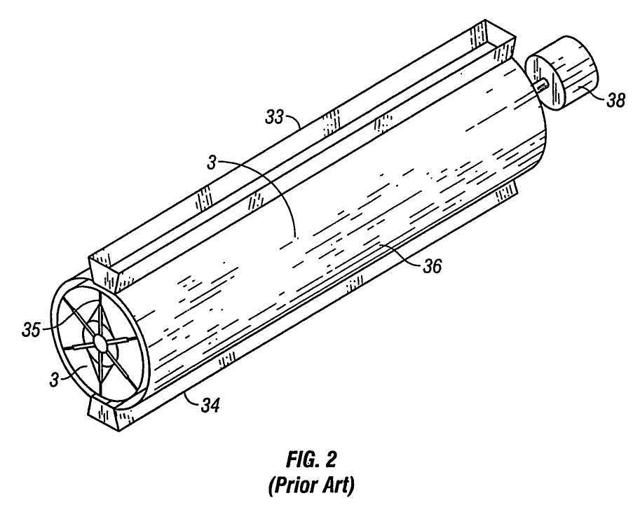

Referring to FIG. 2, an airlock 3 is illustrated, this airlock being well-known in the prior art. Cylindrical body 36 has in the overlying airlock inlet 33 and an underlying airlock outlet 34. Internal rotor 35 having discrete vanes is rotated by motor 38 to meter almonds from inlet 33 to outlet 34 while preventing the through flow of air.

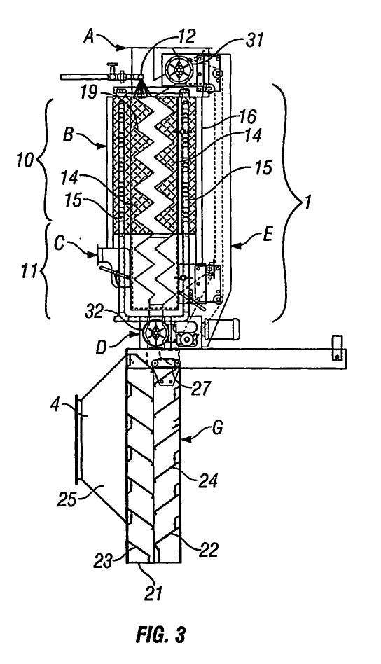

Referring to FIG. 3, steam ladder 1 is illustrated overlying drying ladder 2. In short, almond product is metered in at infeed airlock 31 at the top of steam ladder 1 and falls through a pasteurizing path in upper steam ladder 1. At the end of the pasteurizing path in upper steam ladder 1, almond product is metered through drying ladder airlock 32 to drying ladder 2. In drying ladder 2, cross flowing air dries the almond product of residual moisture and releases the almond product for further processing.

Steam ladder 1 includes an upper oil jacket enclosed steam ladder 10 and a lower open steam ladder 11. Regarding upper enclosed steam ladder 10, the structure consists of enclosed alternating inclined surfaces 19. As in such traditional ladder structures, almonds slide on their major surfaces from the top of the ladder to the bottom of the ladder. Steam nozzle 12 introduces steam at up to 500 degrees Fahrenheit. Upper enclosed steam ladder 10 is dimensioned to enable almonds to have a 4 second to dwell time and be heated to a temperature on the surface of the almonds of at least 160 degrees Fahrenheit. This produces the required sterilization without changing the chemical and taste properties of the almonds.

Upper enclosed steam ladder 10 is surrounded by heated oil jacket 14. The heated oil jacket 14 includes jacket steam heaters 15. Steam inflow through the jacket steam heaters 15 maintains oil within oil jacket 14 about upper enclosed steam ladder 10 at an elevated temperature to assure pasteurization. Insulation covers 16 on the sides of upper enclosed steam ladder 10 prevent unnecessary heat loss from oil and steam.

Pasteurized but moist almond product is metered to drying ladder airlock 32. The drying ladder airlock 32 in turn feeds the moist pasteurized almond product to drying ladder 2. The drying ladder 2 consists of the first drying ladder segment 21 and second drying ladder segment 22. First drying ladder segment 21 has first drying ladder incline surfaces 23. Second drying ladder segment 22 has second drying ladder incline surfaces 24. These respective incline surfaces alternate so that almonds slighting down first drying ladder incline surfaces 23, and fall on to a second drying ladder incline surface 24. In this way the almonds alternatively slide on their alternate major surfaces down the respective incline surfaces.

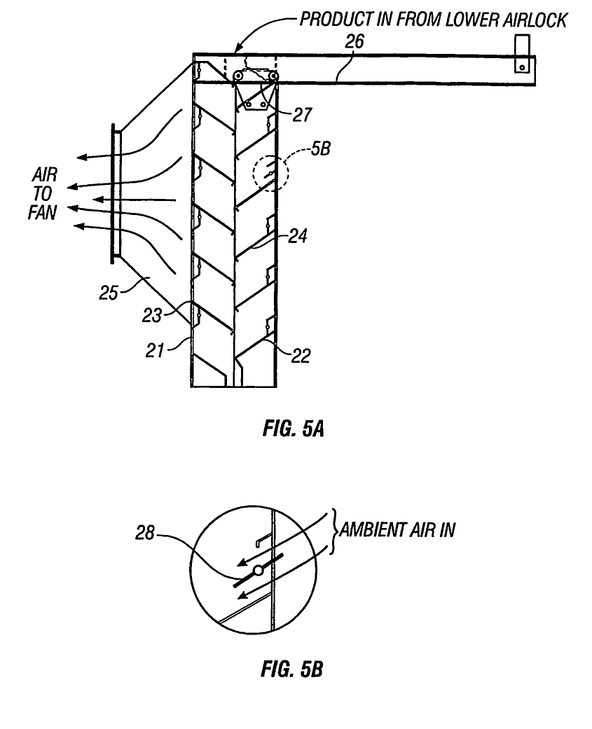

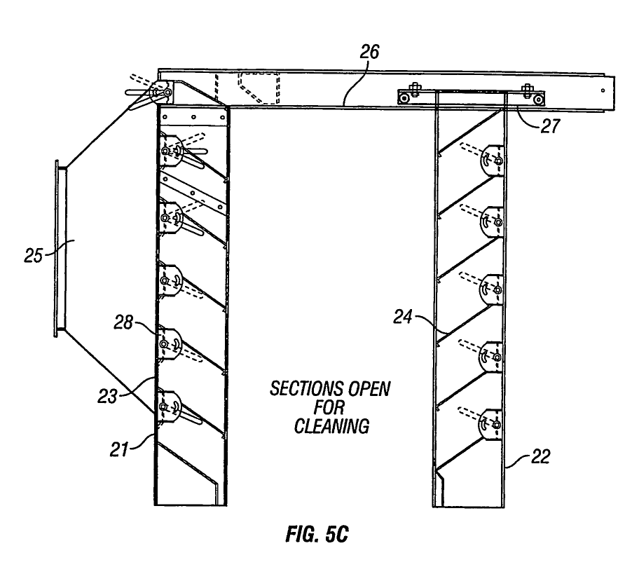

The respective first drying ladder segment 21 and second drying ladder segment 22 are open structures. That is to say, the areas between the respective incline surfaces 23, 24 are open. Referring briefly to FIG. 5B, drying ladder dampers 28 are used control flap valves. These flap valves enable individually adjustable airflow across drying ladder 2. Air ducting discharge 25 draws a vacuum across drying ladder 2. Accordingly, ambient air is pulled across the drying ladder. Consequently, moisture accumulated in sterilization is removed from the almond product. It has been found that an approximate dwell time in excess of two seconds with in the drying ladder produces the required product drying.

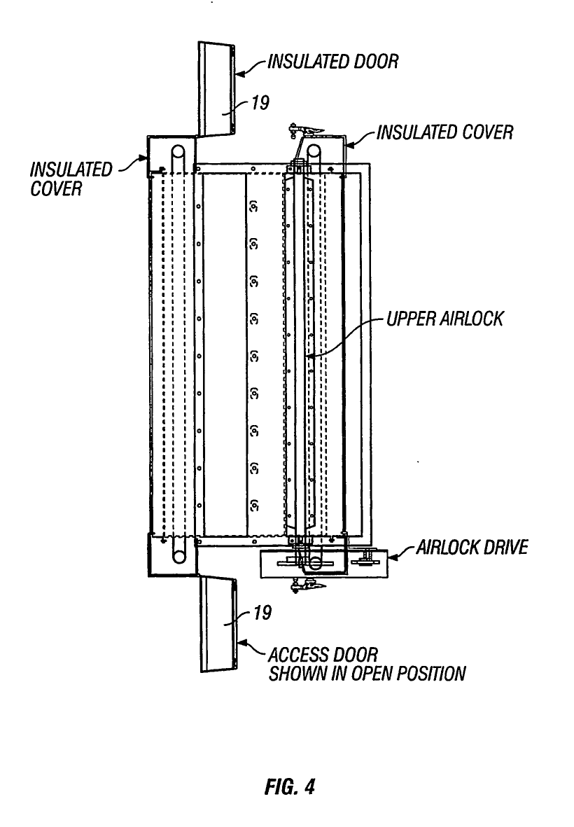

It is been found that provision must be made for respective cleaning of steam ladder 1 and drying ladder 2. Steam ladder 1 is cleaned by opening end doors 19. See FIG. 4.

Referring to FIGS. 5A and 5C, drying ladder 2 includes second drying ladder segment rail 26 suspending the second drying ladder segment 22 from second drying ladder segment car 27. By the expedient of moving the second drying ladder segment 22 away from the first drying ladder segment 21, easy access for cleaning of the lower drying ladder occurs.

The reader will understand that modification of this invention can occur. For the broad practice of the technique here disclosed, all that is required is that the almonds be exposed to pasteurizing steam in a vertical conduit for the requisite period of time and temperature followed by a drying step. For example, we have tried counter flow of both steam and drying air to the falling almonds. Moreover, while we show parallel flow of steam with the almond product, the reader will understand that both cross flow and counter flow of steam to the almond product is operable. Additionally, as of this writing we are considering heating the oil for the oil jacket surrounding the ladder exterior to the oil jacket in a separate heater. This heating can be in addition to the heating here shown with steam lines passing through the jacket. What is illustrated here is the preferred embodiment as of time of the drafting of this patent application.

As of the filing of this Provisional Patent Application, this apparatus was under actual test. While a successful test has not been run with the parameters set forth above, testing indicates that the concept is viable. Accordingly, it has been determined that additional heat energy will be required for sterilization, the parameters of which can be readily determined.

What is claimed is:

1. A process of pasteurizing raw shelled almonds comprising the steps of:
providing an enclosed vertical path for permitting raw shelled almonds to descend from an upper elevation to a lower elevation;
metering raw shelled almonds to the enclosed vertical path to permit the raw shelled almonds to descend along the enclosed vertical path from the upper elevation to the lower elevation;
flowing steam in the enclosed vertical path with the almonds to enable the exterior surface of descending raw shelled almonds to be heated sufficiently to pasteurize the exterior surface of the metered raw shelled almonds in the enclosed vertical path; and,
drying the raw shelled almonds.

2. The process of pasteurizing raw shelled almonds according to claim 1 and wherein the provided enclosed vertical path comprises an enclosed almond ladder.

3. The process of pasteurizing raw shelled almonds according to claim 1 and wherein the metering almonds to the enclosed vertical path step includes:
providing an airlock at the top of the enclosed vertical path;
metering the raw shelled almonds from a vibrating table to the airlock; and,
releasing the raw shelled almonds from the airlock to the enclosed vertical path.

4. The process of pasteurizing raw shelled almonds according to claim 1 and wherein the drying the almonds step includes:
providing a drying ladder having a descending vertical path;
metering the pasteurized raw shelled almonds to the drying ladder to traverse the descending vertical path; and,
flowing air in the drying ladder to dry the raw shelled almonds.

5. The process of pasteurizing raw shelled almonds according to claim 4 wherein the drying the almonds step further includes:
providing an open drying ladder having a descending vertical path; and,
flowing air across the open drying ladder to dry the the raw shelled almonds.

6. The process of pasteurizing raw shelled almonds according to claim 1 and wherein the flowing of steam step includes:
heating the upper portion of the enclosed vertical path; and,
flowing steam into the heated upper portion of the enclosed vertical path to maintain about the almonds steam.

7. The process of pasteurizing raw shelled almonds according to claim 1 further including the steps of:
ventilating the lower portion of the vertical path; and,
removing moisture through the ventilated lower portion of the vertical path.

8. The process of pasteurizing raw shelled almonds according to claim 1 and wherein the provided vertical path includes a vertical length to permit a four-second dwell in the steam to permit pasteurization of the exterior surface of the raw shelled almonds.

9. The process of pasteurizing raw shelled almonds according to claim 1 and wherein the flowing of steam step includes:
flowing steam to produce a temperature of 160 degrees Fahrenheit on the surface of the raw shelled almonds.

10. Apparatus for pasteurizing raw shelled almonds comprising:
an enclosed vertical path for permitting raw shelled almonds to descend from an upper elevation to a lower elevation;
apparatus for metering raw shelled almonds to the enclosed vertical path to permit the raw shelled almonds to descend along the enclosed vertical path from the upper elevation to the lower elevation;
means for flowing steam in the enclosed vertical path to enable the exterior surface of descending raw shelled almonds to be heated sufficiently to pasteurize the exterior surface of the metered raw shelled almonds in the enclosed vertical path; and,
means for drying the raw shelled almonds upon exit from the enclosed vertical path.

11. The apparatus for pasteurizing raw shelled almonds according to claim 10 wherein:
the enclosed vertical path includes an almond ladder.

12. The apparatus for pasteurizing raw shelled almonds according to claim 10 wherein:
the enclosed vertical path is heated; and,
means for introducing steam with the almonds to the enclosed heated vertical path to maintain steam about the almonds.

13. The apparatus for pasteurizing raw shelled almonds according to claim 10 further including:
an airlock at the top of the enclosed vertical path;
means for metering the raw shelled almonds from a vibrating table to the airlock; and,
means for moving the airlock to release the raw shelled almonds from the airlock to the enclosed vertical path.

14. The apparatus for pasteurizing raw shelled almonds according to claim 10 further including:
a drying ladder having a descending vertical path;
means for metering the pasteurized raw shelled almonds to the drying ladder to traverse the descending vertical path; and,
means for flowing the air in the drying ladder to dry the raw shelled almonds.

15. The apparatus for pasteurizing raw shelled almonds according to claim 14 wherein:
the drying ladder has a descending open vertical path;
the means for flowing air in the drying ladder includes a pump for pulling a vacuum at one side of the drying ladder to cause air to flow across the pasteurized raw shelled almonds in the drying ladder.

16. The apparatus for pasteurizing raw shelled almonds according to claim 10 further including:
the drying ladder includes first and second opposed portions; and,
means for moving the first and second opposed portions of the drying ladder towards and away from one another to enable the opposed portions to act as a ladder when they are towards one another and to be cleaned when they are always from one another.

17. A drying ladder for moisturized almonds comprising:
a first ladder segment having inclined surfaces for receiving moisturized almonds and permitting the moisturized almonds to slide on the inclined surfaces from an upper position to a lower position and off the inclined surfaces;
a second ladder segment having inclined surfaces for receiving moisturized almonds and permitting the moisturized almonds to slide on the inclined surfaces from an upper position to a lower position and off the inclined surfaces, the inclined surfaces of the second ladder segment alternating with the inclined surfaces of the first ladder segment whereby almonds descending the respective ladders slide off the inclined surface of one ladder and onto the inclined surface of the other ladder; and,
and air flow path across the first and second ladder segments for permitting drying air to pass across the drying ladder during drying of almonds.

18. The drying ladder for moisturized almonds according to claim 17 and further including:
means for moving the first and second ladder segments towards and away from each other whereby when said the ladder segments are moved towards each other they form and almond ladder and when said letter segments are moved away from one another they can be cleaned.
